(19) United States
(12) Patent Application Publication
(10) Pub. No.: US 2005/0224194 A1
(43) Pub. Date: Oct. 13, 2005

(54) Sectional door and guide assembly therefor

(76) Inventors: Thomas J. Hormann, St. Wendel (DE); Herbert Brinkmann, Halle/Westfalen (DE)

Correspondence Address: FRIEDRICH KUEFFNER, 317 MADISON AVENUE, SUITE 910, NEW YORK, NY, 10017, US

(21) Appl. No.: 10/512,239

(22) PCT Filed: Apr. 25, 2002
(86) PCT No.: PCT/EP02/04612

§ 371 Date: Apr. 14, 2005

(51) Int. Cl. E05D 15/16

(52) U.S. Cl. 160/201

(57) ABSTRACT

The invention relates to a sectional door comprising a door leaf that can be displaced between a closed position and an open position along a path prescribed by a guide rail assembly. Said guide rail assembly comprises two approximately parallel guide rails each having two approximately linear sections that are interconnected by an arched section. The aim of the invention is to improve a sectional door of this type. To this end, an additional guide assembly, which is preferably mounted between the guide rails while serving to guide the movement of the door leaf along the arched section of the prescribed path, is assigned to the door leaf.

The invention pertains to a sectional door with a door leaf, which can be moved along a path predetermined by a guide rail arrangement between a closed position and an open position, where the guide rail arrangement has two more-or-less parallel guide rails, each of which has two more-or-less straight sections connected to each other by a circular arc-shaped section, and to a guide arrangement for a sectional door of this type.

Sectional doors of this type are used in the form of, for example, garage doors and warehouse gates. The door leaf is usually in a vertical plane when the door is closed and in an overhead, horizontal plane when the door is open. The movement of the door between the closed position and the open position is guided by a guide rail arrangement with two guide rails, where each guide rail has a horizontal section parallel to the door leaf when the door is in the open position, a vertical section which is parallel to the door leaf when the door is in the closed position, and a circular arc-shaped section, which connects these two straight sections together. It is possible for the door leaf to move along the arc-shaped section because it is formed out of a plurality of panels, which are arranged in a row along the predetermined path and which are connected to each other by joints, the axes of which are perpendicular to the predetermined path. So that the opening to be blocked off by the door leaf can be closed completely, it is necessary for the panel of the door leaf which leads when the door is being opened to be located in the same plane as the other panels of the door leaf when the door is in the closed position. As long as the room to be closed off by the door leaf has a sufficiently high ceiling, this can be done by installing the arc-shaped section of the guide rails in its entirety above the upper edge of this opening, so that even the panel which leads during the opening movement will have left the arc-shaped section completely by the time the door is closed.

If the dimensions of the room to be closed off by the sectional door do not allow the arc-shaped sections of the guide rails to be installed in this way, the guide rail arrangements can have additional guide rail sections, which serve exclusively to guide the movement of the panel which leads during the opening movement. These additional guide rail sections can be designed without an arc-shaped section, because the edge of the door leaf which leads during the opening movement does not have to be completely deflected. These types of guide rail arrangements are described in, for example, DE 39 38 021 C2 and FR 2 694 331 A1. These guide rail arrangements make it possible for the movement of the door leaf to be guided reliably between the open position and the closed position, and they guarantee at the same time that, even if the ceiling is low, the opening to be blocked off by the door leaf can be closed completely. The design of the corresponding guide rail arrangements, however, is associated with a considerable amount of extra effort, because an additional guide rail section must be made available.

Another possibility for obtaining complete closure of the opening to be blocked off by the door leaf even in the case of a ceiling which is so low that the arc-shaped section of the guide rails cannot be installed above the upper edge of the opening is to mount a guide element, such as a guide roller, which is attached to the panel which leads during the opening movement and which cooperates with the guide rail arrangement to guide the movement of the door leaf, in such a way that it can move with respect to the door leaf in a direction more-or-less perpendicular to the plane of the door leaf, and especially to mount it so that it can pivot around an axis which is perpendicular to the direction of movement of the door leaf. In this case, the panel which leads during the opening movement can be moved away from the guide element and thus also from the guide rail, with the result that the opening to be closed by the door leaf can be blocked off completely even if the arc-shaped section of the guide rail is mounted in the area of the opening to the room. A door is described in WO 95/21,983, furthermore, in which a guide element cooperating with the guide rail arrangement is not provided for the panel which leads during the opening movement.

Especially in cases of sectional doors of the type described last, it has been found that, over the course of prolonged periods of operation involving numerous load cycles, the guide rails can become deformed, and the mountings of the guide rail arrangement can work loose. If a drive unit is also connected to the edge of the door leaf which leads during the opening movement, there will also be the additional problem that the force limiter for the drive unit, which is provided as a conventional safety measure, will not go into effect until after the force acting on the obstacle has reached an excessive and unallowable value. On the other hand, shifting the limit value of the force limiter to a lower value frequently causes the force limiter to respond automatically even at force values which normally occur during conventional operation of the door in the absence of obstacles.

In view of the problems of the state of the art described above, the task of the invention is to provide a sectional door of the type described above which operates reliably over a prolonged period of time and which can also be operated reliably with a drive unit connected to the edge of the door leaf which is in the leading position during the opening movement.

This task is accomplished according to the invention by the elaboration of the known sectional doors indicated in the characterizing clause of Claim 1.

This solution is based on the realization that the problems observed during the operation of the known sectional doors are attributable to the forces of acceleration which act on the guide rail arrangement as the door is traveling along the arc-shaped section of the guide rails. These forces act in a direction perpendicular to the path predetermined by the rails and lead to deformation or to the loosening of the mountings. These forces of acceleration or deflection can reach very high values especially in the case of door leaves equipped with movable guide elements, because the movable attachment of the guide element to the door leaf gives the door leaf an additional degree of freedom of movement. When the door is being closed, this additional freedom allows the door to depart from its predetermined path over the course of the arc-shaped section, and at a later point during the closing movement it allows the edge which trails during the closing movement to be deflected abruptly, which is associated with correspondingly high forces. The departure from the predetermined path along the arc-shaped section of the guide rails occurs especially when the edge of the door leaf which leads during the closing movement strikes an obstacle during the course of the closing movement. In this case, the drive unit, which is typically attached to the edge of the door leaf which leads during the opening movement, causes the guide element to move away from the door leaf in a direction perpendicular to the plane of the door leaf without the force limiter of the drive unit being activated. At the same time, this movement creates lever-like relationships, which intensify the forces exerted by the drive unit on the door leaf in the area of the edge which leads during the closing movement. The load exerted on the obstacle impeding the closing movement can therefore reach a high value before the force limiter responds.

In the inventive elaboration of the known sectional doors, these problems are solved in that an additional guide arrangement, mounted preferably between the guide rails, helps to stabilize the movement of the door leaf and prevents the door leaf from departing too far from the predetermined path and thus also prevents the creation of the previously described lever-like relationships and their negative effects. As a result, both excessive load on the guide rails and excessive load on the obstacles impeding the movement of the door leaf during the course of the closing movement of the door leaf are also prevented.

An especially simple way to realize the design of the additional guide arrangement according to the invention is to provide it with a permanently mounted contact element. This contact element can be attached, for example, in the area of the lintel of the opening to be closed off by the door leaf. So that it can guide the movement of the door leaf, the contact element can have a contact surface designed to cooperate with the edge of the door leaf which leads during the opening movement. This contact surface is modeled after the arc-shaped section of the predetermined path. It has been found to be both especially simple with respect to design and yet also very effective to provide the contact element with a contact surface, which, in a plane of projection perpendicular to the predetermined path, extends between the arc-shaped section and the straight sections and/or at least along or parallel to part of a secant of the arc-shaped section. Because of the distance between the guide elements attached to the door leaf and the door leaf in a direction perpendicular to the plane of the door leaf, the contact surface will usually be parallel to a secant of the arc-shaped section and, in a plane of projection perpendicular to the predetermined path, can be located completely outside the surface enclosed by the arc-shaped section and the straight sections of the guide rails.

As already explained above, the permanently mounted contact element which guides the movement of the door leaf cooperates with the edge of the door leaf which leads during the opening movement. Damage to the door leaf in the area of this edge and/or impairment to the movement of the door leaf as the leaf travels along the arc-shaped section of the guide rails can be avoided by providing the guide arrangement with a second contact element, which is mounted on the edge which leads during the opening movement, this second contact element being more-or-less perpendicular to the predetermined path. This second contact element is able to make contact with the first contact element during the closing movement. It projects beyond the door leaf in a direction perpendicular to the plane of the door leaf and therefore arrives in contact with the permanently mounted contact element even though this first, permanently mounted contact element is located in such a way that it cannot interfere with the movement of the door leaf before the second contact element makes contact with it.

It has already been explained above that the invention can be used to particular advantage in sectional doors with a drive unit connected to the door leaf. In this case, the second contact element can be used for a double function. That is, it can also be used to avoid the damage to the door leaf which could occur as a result of the connection of the drive unit to the door. This second function is achieved by connecting the drive unit to the door leaf at a point between the guide rails in the area of the second contact element.

It also possible within the scope of the invention to upgrade previously installed sectional doors with the arrangement according to the invention. An additional guide arrangement suitable for this purpose consists essentially of a first contact element, which can be permanently mounted in the area of a soffit of an opening, and a second contact element, which can be attached to the edge of the door leaf which leads during the opening movement.

The invention is explained in greater detail below on the basis of the drawing, to which reference is explicitly made for all details which are essential to the invention but which have not been discussed in detail above:

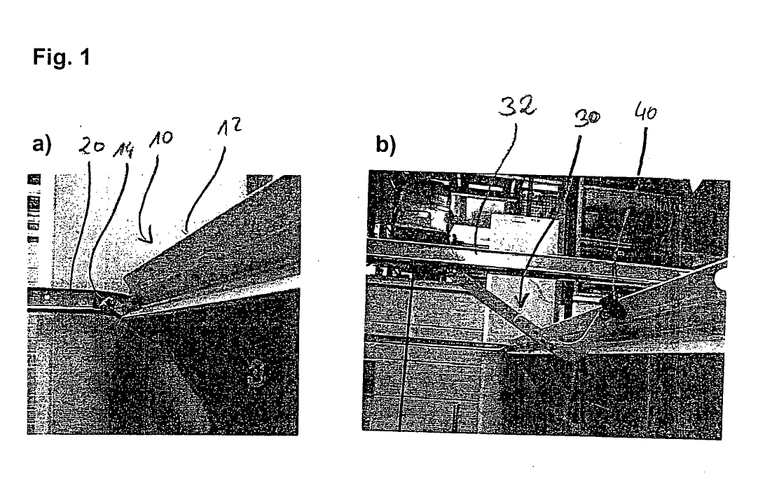

FIG. 1 shows a view of an inventive sectional door during the first phase of the closing movement of the door leaf;

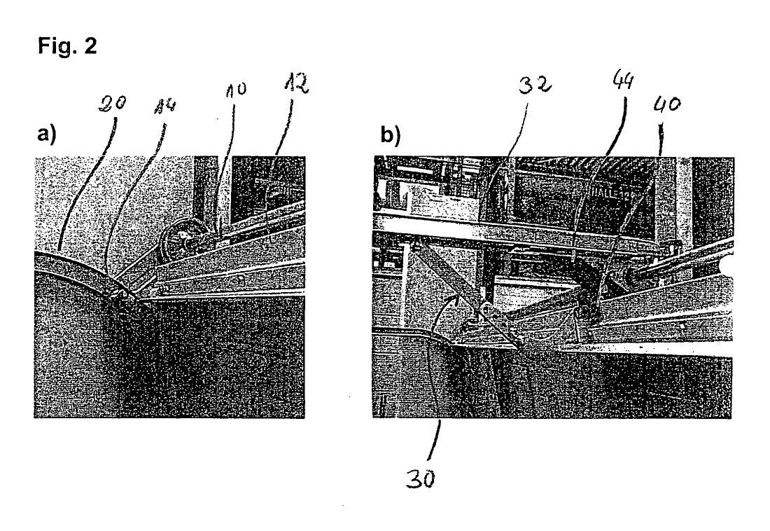

FIG. 2 shows a view similar to FIG. 1 during the second phase of the closing movement; and

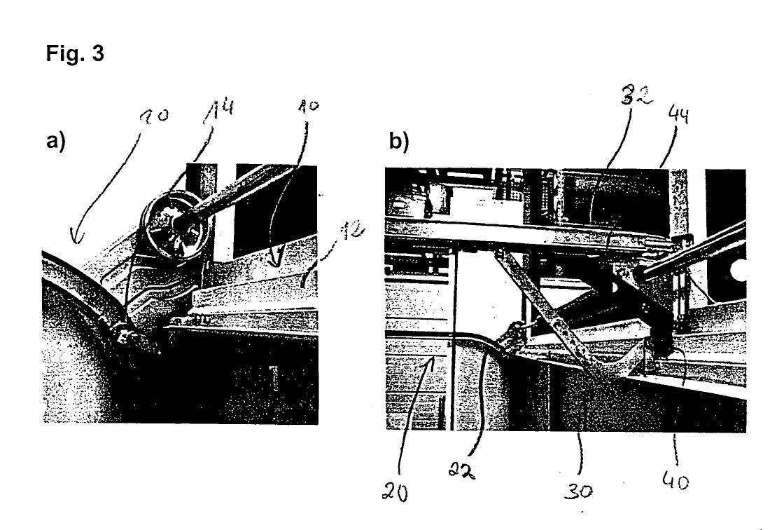

FIG. 3 shows a view similar to FIG. 1 after the closed position has been reached.

FIG. 1 shows a part of a door leaf, designated overall by the number 10, of a sectional door comprising the panel 12 which leads during an opening movement. According to FIG. 1a, the movement of the door leaf between an open position and a closed position is guided by guide rails 20, which cooperate with a guide element 14, attached to the panel 12. From a comparative evaluation of FIGS. 1a-3a, it can be seen that the guide element 14, realized in the form of a guide roller, can move with respect to the door leaf in a direction perpendicular to the plane of the door leaf by pivoting around an axis perpendicular to the guide rail 20.

According to FIGS. 1b-3b, the door leaf 10 is connected to a drive device by a lever arrangement 30, which is attached at one end to the edge of the door leaf 10 which leads during the opening movement and at the other end to a traction means held in a guide 32. The lever arrangement 30 is hinged at one end to the door leaf 10 by way of a contact element attached to the edge of the door leaf 10 which leads during the opening movement and is hinged at the other end to a traction means, which is driven by a drive unit and held in a guide profile 32.

As can be seen in FIGS. 2 and 3, the guide roller 14 is pivoted away from the door leaf 10 when it reaches the closed position. As a result, the contact element 40 attached to the door leaf 10 makes contact with a contact surface of a contact element mounted above the opening to be closed by the door leaf 10, the contact surface of this element being parallel to a secant of the arc-shaped section 22 of the arc-shaped path. During the further course of the. movement of the door leaf 10, the edge of the door leaf 10 which leads during the opening movement is pushed downward at a slant by the sliding contact of the contact element 40 against the contact element 44. The guidance of the door leaf movement thus produced relieves the load on the arc-shaped sections 22 of the guide rails and simultaneously avoids the creation of lever relationships, which can lead to an excessive increase in the force exerted via the lever arrangement 30 on the door leaf 10.

The invention is not limited to the exemplary embodiment explained on the basis of the drawing. On the contrary, it is also intended to include the use of guide arrangements which have only a permanently mounted contact element, which cooperates directly with an edge of the door leaf. Otherwise, the invention can also be applied advantageously to so-called side-closing sectional doors, in which the door leaf moves between the open and closed position along guide rails which are all horizontal. In addition, the invention can also be used advantageously in the case of sectional doors in which no motor drive is provided or in which the motor drive represents only an upgrade option.

1. Sectional door with a door leaf (10), which can be moved between an open position and a closed position along a path predetermined by a guide rail arrangement, where the guide rail arrangement has two guide rails (20), which are more-or-less parallel to each other and each of which consists of two more-or-less straight sections connected to each other by a circular arc-shaped section, wherein an additional guide arrangement (40, 44) located between the guide rails (20) is assigned to the door leaf (10) to guide the movement of the door leaf along the arc-shaped section of the predetermined path, which guide arrangement has a contact surface, which cooperates with the edge of the door leaf which leads during the opening movement to guide the movement of the door leaf and which, by sliding contact with this edge, pushes it downward at a slant during the closing movement.

2. Sectional door according to claim 1, wherein the door leaf (10) has a plurality of panels (12), which are arranged in a row along the predetermined path, and which are connected to each other by joints, the axes of which are perpendicular to the predetermined path.

3. Sectional door according to claim 2, wherein at least one guide element (10), which cooperates with the guide rail arrangement and which can be moved, especially pivoted, relative to the door leaf in a direction perpendicular to the plane of the door leaf, is mounted on at least one panel (12), especially on the panel which is in the leading position during the opening movement.

4. Sectional door according to claim 1, wherein the first contact element has a contact surface which, in a plane of projection perpendicular to the predetermined path, extends between the arc-shaped section and the straight sections and/or along or parallel to at least part of a secant of the arc-shaped section.

5. Sectional door according to claim 1, wherein the guide arrangement has a second contact element (40), which is mounted on the edge which leads during the opening movement, is more-or-less perpendicular to the predetermined path, and can make contact with the first contact element (44) during the closing movement.

6. Sectional door according to claim 1, comprising a drive unit connected to the door leaf (10).

7. Sectional door according to claim 6, wherein the drive unit is connected to the door leaf (10) at a point between the guide rails (10), especially in the area of the second contact element (40).
